(19) United States
(12) Patent Application Publication
(10) Pub. No.: US 2011/0145709 A1
(43) Pub. Date: Jun. 16, 2011

(54) APPARATUS AND METHOD FOR DIGITAL IMAGE PROCESSING USING SLIDESHOW FUNCTION

(75) Inventors: Jeoung-gon Yoo, Suwon-si (KR); Sung-ho Eun, Seoul (KR)

(73) Assignee: Samsung Electronics Co., Ltd., Suwon-si (KR)

(21) Appl. No.: 12/963,805

(22) Filed: Dec. 9, 2010

(30) Foreign Application Priority Data
Dec. 11, 2009 (KR) 10-2009-0123391

(51) Int. Cl. G06F 3/01

(52) U.S. Cl. 715/730

(57) ABSTRACT

An image processing apparatus having a slideshow function includes: a storage unit that stores files corresponding to a plurality of images; a display unit that displays the plurality of images; a slideshow performing unit that reads the files from the storage unit and sequentially displays the plurality of images on the display unit in a slideshow function; a user input unit that receives input manipulation of a user and generating a signal; and an image processor that performs image processing on the files corresponding to images selected from the plurality of images displayed on the display unit based on the signal of the user input unit after the slideshow performing unit completes the slideshow function.

### CROSS-REFERENCE TO RELATED PATENT APPLICATION

This application claims the priority benefit of Korean Patent Application No. 10-2009-0123391, filed on Dec. 11, 2009, in the Korean Intellectual Property Office, the disclosure of which is incorporated herein in its entirety by reference.

### BACKGROUND

1. Field of the Invention

Embodiments relate to an apparatus and method for digital image processing using a slideshow function, and more particularly, to an apparatus and method for digital image processing, wherein a plurality of images are selected when a slideshow function is performed and image processing is easily performed on the selected images after the slideshow function is completed.

2. Description of the Related Art

Image processing apparatuses, such as digital cameras, display photographed pictures using display devices, such as LCDs. A slideshow function is intended to automatically display images stored in an image processing apparatus sequentially at a predetermined interval.

While the slideshow function is generally used to appreciate images stored in an image processing apparatus, image processing may be performed on the stored images, such as deleting them, changing color thereof, resizing the images, cropping and restoring them after statuses of images are checked through slideshows.

However, the conventional image processing apparatuses inconveniently need to stop the slideshow function and search a specific image in order to perform image processing on the specific image.

In addition, the conventional image processing apparatuses inconveniently need to check a filename of each image and perform image processing on the images one by one in order to delete the images or edit them in the same way.

### SUMMARY

Embodiments include an apparatus and method for digital image processing using a slideshow function.

Embodiments also include an apparatus and method for digital image processing wherein a plurality of images on which image processing is performed are selected when a slideshow function is performed.

Embodiments also include an apparatus and method for digital image processing wherein image processing is performed on images that are selected while a slideshow function is performed.

According to an embodiment, an image processing apparatus having a slideshow function includes: a storage unit that stores files corresponding to a plurality of images; a display unit that displays the plurality of images; a slideshow performing unit that reads the files from the storage unit and sequentially displays the plurality of images on the display unit in a slideshow function; a user input unit that receives input manipulation of a user and generates a signal; and an image processor that performs image processing on the files corresponding to images selected from the plurality of images displayed on the display unit based on the signal of the user input unit after the slideshow performing unit completes the slideshow function.

The image processor may perform the same image processing on each of the selected images.

When the slideshow function is performed, the display unit may display selectable types of image processing to be performed on the selected images, the user input unit may select a type of image processing to be performed on each of the selected images, and the image processor may perform image processing selected by the user input unit on each of the selected images.

The image processing performed by the image processor may include one operation selected from the group consisting of a deleting operation of deleting the selected files from the storage unit, a property editing operation of endowing a protection property on the selected files, and a printing operation of printing images corresponding to the selected files.

The image processing performed by the image processor may include one operation selected from the group consisting of a coloring operation of applying a color effect to the images corresponding to the selected files, a resizing operation of resizing the images, a rotating operation of changing orientations of the images, a cropping operation of cropping the images, and a redeye correction operation of correcting a red eye phenomenon that occurs in persons included in the images.

The image processing apparatus may further include: a list creating unit that creates a list of filenames of the selected images, wherein the image processor performs image processing on the images included in the list.

The image processor may insert a common character string in the filenames of the selected images, and the slideshow performing unit may perform image processing on the selected images having the filenames including the common character string after completing the slideshow function.

The image processor may move the files of the selected images to a temporary folder, and the slideshow performing unit may perform image processing on the images stored in the temporary folder after completing the slideshow function.

The image processor may endow a tag on a user region of each of the files of the selected images, and the slideshow performing unit may perform image processing on the images including the tag after completing the slideshow function.

According to another embodiment, an image processing method using a slideshow function includes: sequentially displaying a plurality of images; receiving user manipulation of a user and selecting at least some of the displayed images when the slideshow function is performed; and performing image processing on the selected images.

### BRIEF DESCRIPTION OF THE DRAWINGS

The above and other features and advantages will become more apparent by describing in detail exemplary embodiments with reference to the attached drawings in which:

FIG. 1 is a schematic block diagram of the elements of an image processing apparatus having a slideshow function, according to an embodiment;

FIG. 2 is a conceptual view for explaining image processing performed by the image processing apparatus of FIG. 1, according to an embodiment;

FIG. 3 is a flowchart illustrating operations of an image processing method using a slideshow function, according to an embodiment;

FIG. 4 illustrates an operation of setting selections relating to a slideshow function using the image processing method of FIG. 3, according to an embodiment;

FIG. 5 illustrates an operation of performing a slideshow function using the image processing method of FIG. 3, according to an embodiment;

FIG. 6 illustrates an operation of performing image processing on selected images during a slideshow using the image processing method of FIG. 3, according to an embodiment;

FIG. 7 is a flowchart illustrating operations of an image processing method using a slideshow function, according to another embodiment;

FIG. 8 is a conceptual view for explaining image processing performed by the image processing apparatus of FIG. 1, according to another embodiment;

FIG. 9 is a conceptual view for explaining image processing performed by the image processing apparatus of FIG. 1, according to another embodiment; and

FIG. 10 is a conceptual view for explaining image processing performed by the image processing apparatus of FIG. 1, according to another embodiment.

### DETAILED DESCRIPTION

Hereinafter, the structure and operation of embodiments of an apparatus and method for digital image processing using a slideshow function will be described in detail with reference to the attached drawings.

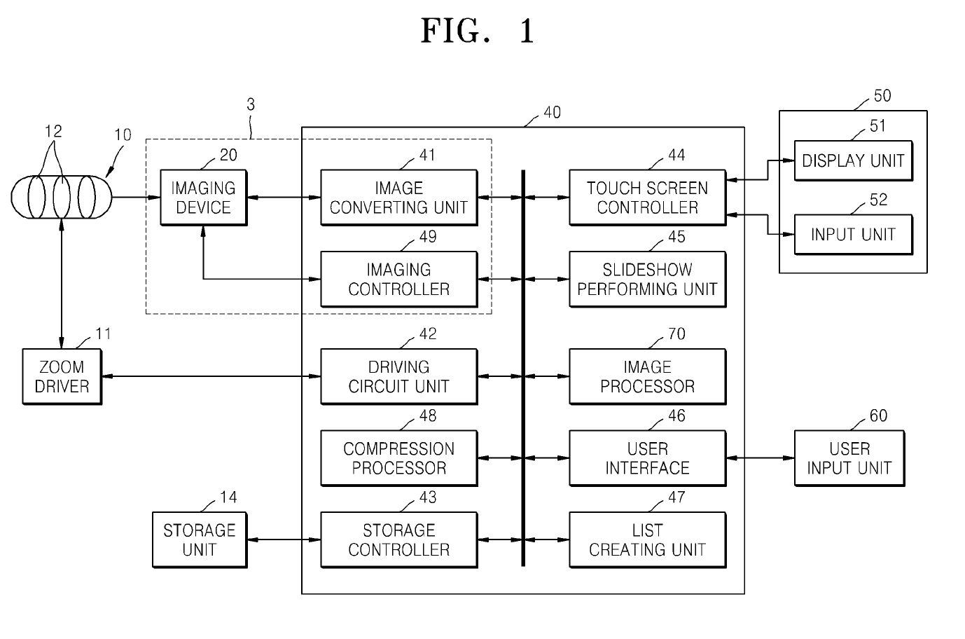

FIG. 1 is a schematic block diagram of the elements of an image processing apparatus having a slideshow function, according to an embodiment.

Referring to FIG. 1, the image processing apparatus having the slideshow function according to the present embodiment includes a storage unit 14 that stores a plurality of files corresponding to images, a display unit 51 that displays an image, a slideshow performing unit 45 that sequentially displays images on the display unit 51, a user input unit 60 that receives input manipulation of a user and generates a signal, and an image processor 70 that performs image processing on images selected during the slideshow.

Although the image processing apparatus of FIG. 1 is realized as a digital camera, this should not be construed as limiting, as the image processing apparatus of FIG. 1 can be implemented as various types of electronic devices, such as a digital album or a portable media player (PMP), which may display an image and perform the slideshow function and do not include an imaging unit 3.

The image processing apparatus may select a plurality of images when the slideshow function is performed, and perform image processing on the selected images simultaneously after the slideshow function is performed.

The image processing apparatus may include the imaging unit 3 that captures an image. The imaging unit 3 includes an imaging device 20 that captures the image of a subject and converts the captured image into an electrical signal, an image converting unit 41 that converts the electrical signal transmitted by the imaging device 20 into image data, and an imaging controller 49 that controls operation of the imaging device 20. The image light of a subject is incident to the imaging device 20 through an optical system 10 disposed in front of the imaging device 20.

The optical system 10 disposed in front of the imaging device 20 includes a plurality of lenses 12, and forms an image on a surface of the imaging device 20 by using external image light. The lenses 12 are disposed such that intervals therebetween are changeable. By changing the intervals of the lenses 12, a zoom magnification and a focus of the optical system 10 may be controlled.

The lenses 12 are driven by a zoom driver 11 having a driving unit, such as a zoom motor, for changing the relative locations of the lenses 12. The lenses 12 may include a zoom lens for enlarging or reducing the size of the image of a subject, and a focus lens for controlling focusing of a subject. The zoom driver 11 is driven in correspondence to a control signal applied by a driving circuit unit 42 of a controller 40. Thus, the zoom driver 11 may drive the optical system 10 so that the optical system 10 has any one of a plurality of enlargement magnifications.

The imaging device 20 may include a photoelectric conversion device such as a charge-coupled device (CCD) or a complementary metal-oxide semiconductor (CMOS), and converts an image light that enters through the optical system 10 into an electrical signal. The imaging device 20 is driven in correspondence to a control signal applied by the imaging controller 49.

The image converting unit 41 performs image processing on the electrical signal of the imaging device 20 or converts the electrical signal into image data that may be stored in a storage medium.

The electrical signal transmitted by the imaging device 20 may be converted by the image converting unit 41 according to the following method. For example, the method may include: reducing driving noise of the electrical signal transmitted by the imaging device 20 by using a correlated double sampling (CDS) circuit; adjusting the gain of a signal obtained after noise is reduced, wherein the adjusting is performed by an automatic gain control (AGC) circuit; converting an analog signal into a digital signal by using an analog-to-digital (A/D) converter; and performing correcting for pixel defects with respect to a digital signal, gains correction, white balance correction, and gamma correction. The CDS circuit, the AGC circuit, and the A/D converter may be independent circuits.

The image converting unit 41 may convert the electrical signal of the imaging device 20 into RGB data and then convert the RGB data into raw data such as a YUV signal including a luminescence Y signal and a color difference UV signal.

The controller 40 is electrically connected to the imaging device 20, the zoom driver 11, a touch screen 50, the user input unit 60, and the storage unit 14. The controller 40 exchanges control signals with these elements in order to control operation of the elements, and processes data.

The controller 40 may include the image converting unit 41, the driving circuit unit 42, a touch screen controller 44, a storage controller 43 that controls storage of data in the storage unit 14, the imaging controller 49, a user interface 46, the slideshow performing unit 45, a compression processor 48, the image processor 70, and a list creating unit 47. The controller 40 may be embodied as a microchip or a circuit board including a microchip, and constituents of the controller 40 may be embodied by software or circuits installed in the controller 40.

The storage controller 43 controls writing of data to the storage unit 14 and reading of the written data or set information. The storage unit 14 may include a volatile internal memory. The volatile internal memory may include a semiconductor memory device such as a synchronous dynamic random access memory (SDRAM). The storage unit 14 may perform a buffer memory function for temporarily storing raw data generated by the image processor 70, and an operation memory function that is used when the image processor 70 processes data.

The storage unit 14 may also include a non-volatile external memory. The non-volatile external memory may be, for example, a memory stick, a flash memory such as secure digital (SD)/multimedia card (MMC), a storage device such as a hard disk drive (HDD), or an optical storage device such as a DVD or CD. The storage unit 14 may store image data that is compressed in the form of a JPEG file or a TIFF file by the compression processor 48.

The image processing apparatus according to the present embodiment may include the touch screen 50 that includes a display unit 51 that displays an image of a file stored in the storage unit 14 and an input unit 52 that selects a portion of the image displayed by the display unit 51. The touch screen 50 may display an image captured by the imaging device 20 and generate a signal corresponding to a touched location by sensing the touch on a surface of the touch screen 50.

The touch screen 50 is an input device that may be used instead of a keyboard and a mouse. Since the touch screen 50 allows a user to directly touch the surface of a display with a finger or a pen in order to perform a desired operation, the user may perform desired operations under a graphical user interface (GUI) environment.

The display unit 51 of the touch screen 50 may be a display device such as a liquid crystal display (LCD) or an organic light-emitting display (OLED). The display unit 51 may display an image corresponding to image data stored in the storage unit 14.

The input unit 52 may be installed on a surface of the display unit 51 and senses a touch of the surface of the display unit 51. The input unit 52 may be an example of the user input unit 60 included in the image processing apparatus according to the present embodiment. The input unit 52 may include a resistance sensing unit, a capacitive sensing unit, a sensing unit using a surface acoustic wave, a sensing unit using infrared (IR) rays, or an optical sensing unit.

By contacting the input unit 52 of the touch screen 50, a user selects a menu in an image displayed by the display unit 51 and performs the due operation, or designates an identified region.

The image processing apparatus may include the user input unit 60 that is separately formed from the touch screen 50. The user input unit 60 may be embodied as, for example, menu buttons or a dial. A user may manipulate the user input unit 60 when reduced images are displayed by the display unit 51, in order to perform a slideshow function and select images. The user input unit 60 generates an input signal by recognizing manipulation of a user, and applies the generated input signal to the user interface 46.

The compression processor 48 may compress image data generated by the imaging unit 3 or extract the compressed image data. The image data may be compressed in the form of a JPEG file or a TIFF file. JPEG is an image compression standard set by the Joint Photographic Experts Group, and is a file format that is a widely used to compress a still image such as a picture owing to its high compression efficiency.

The slideshow performing unit 45 performs the slideshow function of sequentially displaying the images corresponding to the files stored in the storage unit 14 on the display unit 51 at a predetermined time interval. The slideshow performing unit 45 controls the storage controller 43 to sequentially read the files stored in the storage unit 14, decompresses the files read by controlling the compression processor 48, and controls the touch screen controller 44, thereby forming the images on the display unit 51.

The user input unit 60 may receive an input manipulation of the user when the slideshow function of sequentially displaying the images corresponding to the files stored in the storage unit 14 on the display unit 51 is performed. In more detail, the user may select images through the user input unit 60 or by manipulating the input unit 52 of the touch screen 50 when the slideshow function is performed.

The slideshow performing unit 45 may memorize the images selected by the user from among the images displayed according to the slideshow function based on an input signal of the user input unit 60. The slideshow performing unit 45 memorizes the selected images in order to perform image processing on the images selected by the user after the slideshow function is completed. The image processing apparatus according to the present embodiment includes the list creating unit 47 that creates a list of the files of the selected images in order to memorize the selected images in the slideshow performing unit 45.

Although the slideshow performing unit 45 and the list creating unit 47 of FIG. 1 are independent elements, this should not be construed as limiting, as the list creating unit 47 may be included in the slideshow performing unit 45. The slideshow performing unit 45 may be realized as a circuit included in the controller 40 or software embedded in a semiconductor device.

After the slideshow performing unit 45 completes the slideshow function, the image processor 70 performs image processing on the selected images based on the input signal of the user input unit 60.

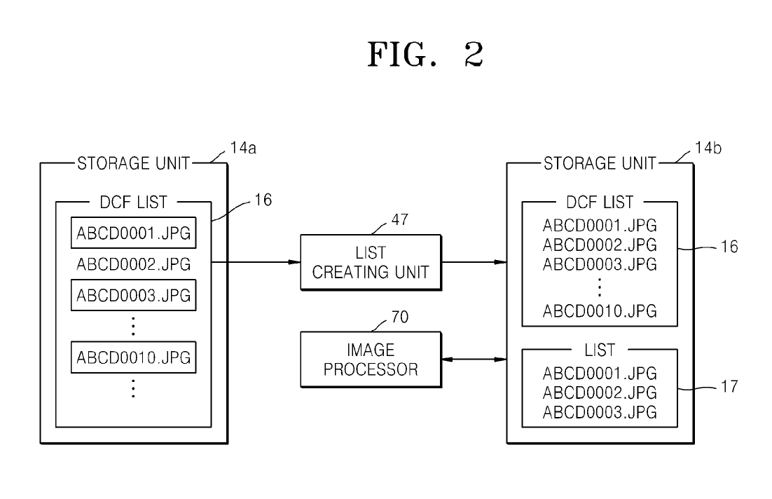

FIG. 2 is a conceptual view for explaining image processing performed by the image processing apparatus of FIG. 1, according to an embodiment.

Referring to FIG. 2, although storage units 14a and 14b are the same as the storage unit 14 of FIG. 1, the storage unit 14a shows a status before a slideshow function is performed, and the storage unit 14b shows that a list 17 is created by the list creating unit 47 after the slideshow function is completed. Portable digital devices, such as a digital camera, a digital still camera (DSC), a camera mobile phone, a digital video camera (DVC), a digital media player, and PDA, store an image and audio data (multimedia content) according to a predetermined naming rule.

An image photographed by a digital image processing apparatus is recorded in JPG or TIF file format. A file name follows the design rule for camera file system (DCF) standard.

DCF is a file format standardized by Japan Electronics and Information Technology Industries Association (JEITA) and specifies how to store and use data of a digital camera. It is advantageous that a picture photographed by a digital camera following the DCF file format can be reproduced in other digital camera devices.

An image processing apparatus that follows the DCF file format includes an uppermost digital camera image (DCIM) directory under a root directory. A plurality of files having an 8 digit filename in combination of 4 characters and 4 serial numbers that can be designated by a user may be recorded in the DCIM directory.

The storage unit 14a includes a DCF list 16. The image processing apparatus sequentially displays images corresponding to files included in the DCF list 16, thereby performing the slideshow function. When the slideshow function is performed, if the user selects images, the list creating unit 47 may create the list 17 of files of the selected images and record the list 17 onto the storage unit 14b. The storage unit 14b in which the list 17 of the files corresponding to the selected images is stored may be a volatile internal memory or an external memory.

The image processor 70 may perform image processing on the files included in the list 17. The image processing performed by the image processor 70 may, for example, include a deletion operation of deleting the selected images, a property editing operation of protecting the selected files from being undeleted from the image processing apparatus by endowing protection property on the selected files, and a printing operation of printing images corresponding to the selected files.

When images are printed, the image processor 70 may form a digital print order format (DPOF). DPOF is a standard printing file specification suitable for a digital camera.

The image processing performed by the image processor 70 may further include a coloring operation of applying a color effect to the images corresponding to the selected files, a resizing operation of resizing the images, a rotation operation of changing directions of the images, a cropping operation of cropping the images, and a redeye correction operation of correcting a red eye phenomenon that occurs in persons included in the images.

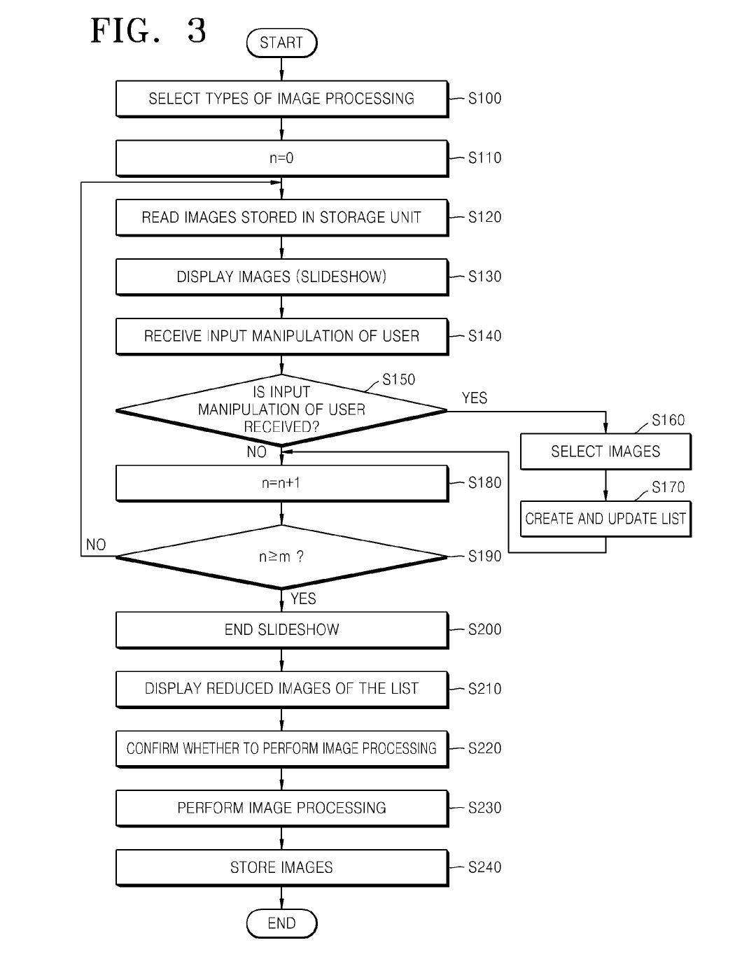

FIG. 3 is a flowchart illustrating operations of an image processing method using a slideshow function, according to an embodiment.

Referring to FIG. 3, the image processing method according to the present embodiment includes a slideshow operation (S130) that sequentially displays a plurality of images, a selection operation (S160) that selects some of the displayed images, and an image processing operation (S230) that performs image processing on the selected images.

Although not shown, details for the slideshow function may be set before the slideshow operation (S130) is performed. The details for the slideshow function include, for example, a time interval for the slideshow, a music file to be reproduced or types of special effects, etc. during the slideshow.

An operation (S100) in which types of image processing are selected is performed before the slideshow operation (S130). The selected image processing types are to be performed on images selected during the slideshow function.

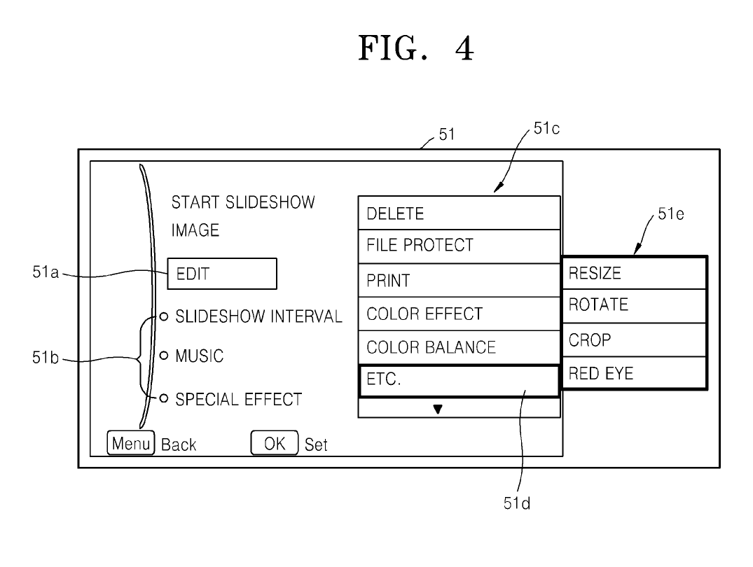

FIG. 4 illustrates an operation of setting selections relating to a slideshow function using the image processing method of FIG. 3, according to an embodiment.

Referring to FIG. 4, the display unit 51 displays a slideshow function menu 51b and an image processing type setting menu 51a. When a user manipulates the image processing type setting menu 51a, the display unit 51 displays function menus 51c and 51e.

The user may delete selected images, protect selected files from being deleted from an image processing apparatus by endowing a protection property on the selected files, print images corresponding to the selected files, or apply a color effect or color balance to images corresponding to the selected files, by selecting one of the functions of the function menu 51c.

The user may resize the images, change directions of the images, crop the images, and correct a red eye phenomenon that occurs in persons included in the images, by selecting one of the functions of the function menu 51e that appears after selecting an item ETC. 51d from the function menu 51c.

Referring back to FIG. 3, the image processing method may include reading (S120) files corresponding to a plurality of images stored in a storage unit, decompressing the read files (not shown), and performing the slideshow function to display the images (S130).

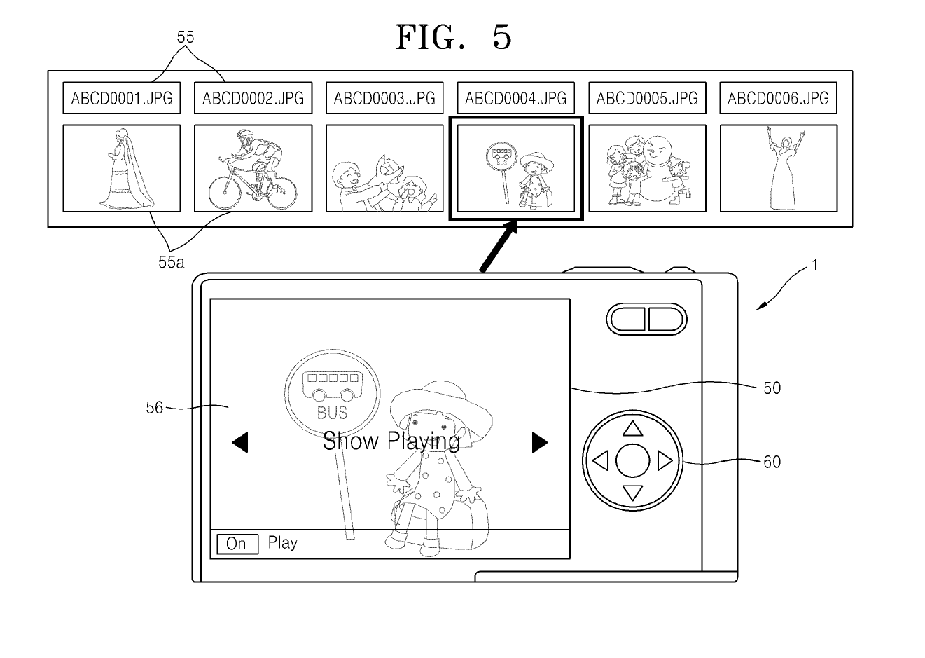

FIG. 5 illustrates an operation of performing a slideshow function using the image processing method of FIG. 3, according to an embodiment. Referring to FIG. 5, an image processing apparatus 1 performs the image processing method of FIG. 3 and sequentially displays a plurality of images 55a corresponding to files included in a DCF list 55 stored in a storage unit on the touch screen 50. A user manipulates the touch screen 50 or the user input unit 60 to select a currently displayed image 56.

Referring back to FIG. 3, an operation (S140) of receiving an input manipulation of the user is performed when an image is displayed. If the input manipulation of the user is received (S150), an operation (S160) of selecting currently displayed images and an operation (S170) of creating and updating a list including selected images are performed. According to a first selection of the currently displayed images, the list is created. According to second and more selections of the currently displayed images, the list is updated.

Thereafter, a parameter n that is initialized (S110) to 0 before the slideshow function is performed increases by 1 (S180) whenever images are changed (e.g., from a first displayed image to a second displayed image in the slideshow). The slideshow function is repeatedly performed until the parameter n reaches m, which is the total number of images to be displayed (S190).

When the slideshow function is completed (S200), an operation (S210) of displaying reduced images corresponding to the files included in the list created in operation S170 is performed. When the reduced images are displayed, an operation (S220) of checking a user's opinion whether to perform image processing on the displayed images may be performed. If image processing is performed (S230) on the displayed images, an operation (S240) of storing the images on which image processing has been performed may be performed.

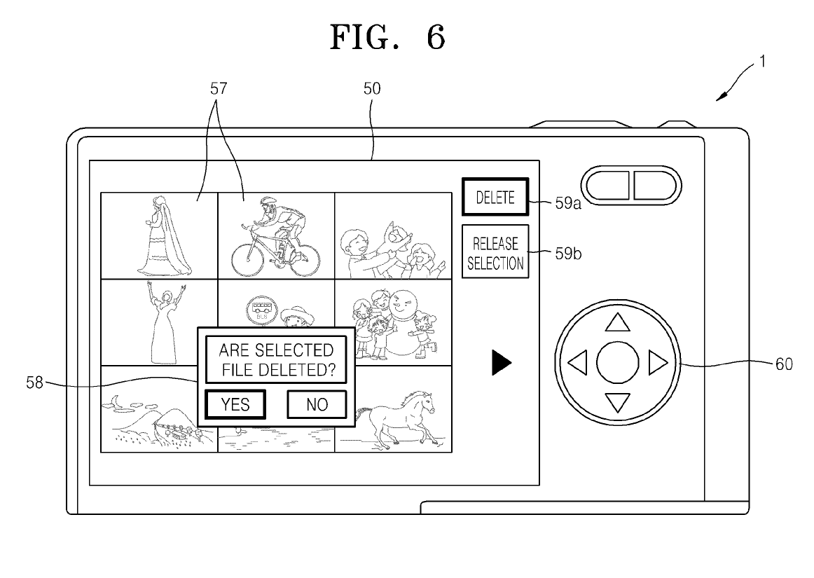

FIG. 6 illustrates an operation of performing image processing on selected images during a slideshow using the image processing method of FIG. 3, according to an embodiment.

Referring to FIG. 6, the touch screen 50 of the image processing apparatus 1 displays the reduced images 57 of the images corresponding to the files included in the list created in operation S170. Image processing may be performed on the reduced images 57 that have been confirmed by a user.

When the user manipulates a delete execution menu 59a, the touch screen 50 displays a dialogue box 58 that asks the user whether to perform image processing (e.g., file delete). If the user contacts the user input unit 60 or the touch screen 50 and selects “yes” from the dialogue box 58, image processing set in the operation (S100), in which types of image processing are selected, may be performed.

The user may change the reduced images 57 on which image processing is to be performed by selecting “no” from the dialogue box 58 and manipulating a release selection menu 59b.

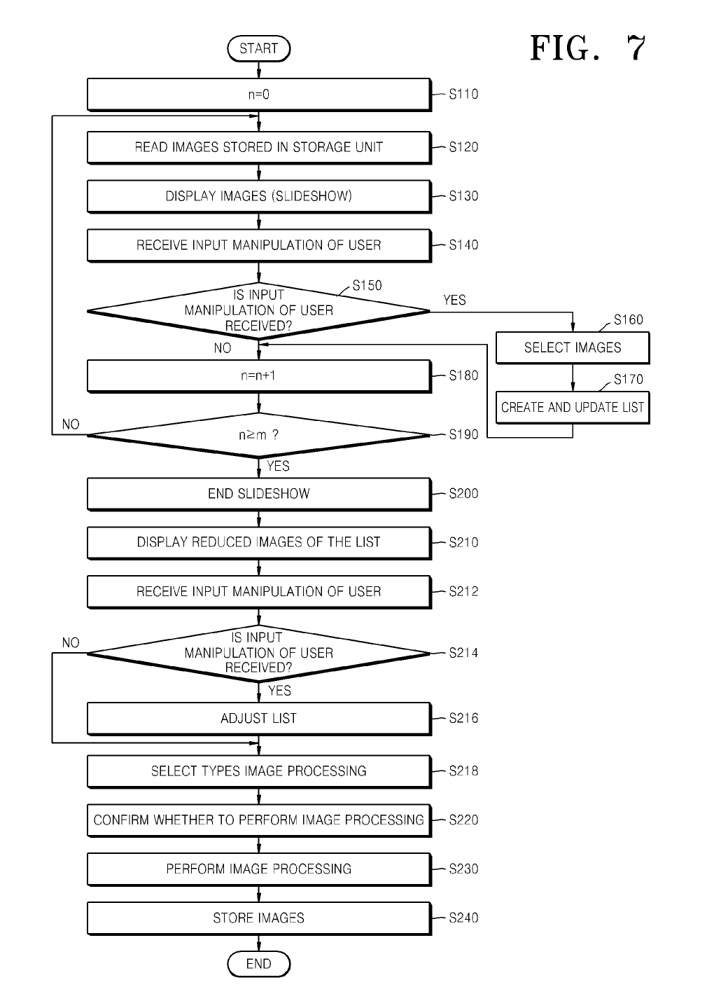

FIG. 7 is a flowchart illustrating operations of an image processing method using a slideshow function, according to another embodiment.

Referring to FIG. 7, the image processing method according to the present embodiment includes a slideshow operation (S130) that sequentially displays a plurality of images, a selection operation (S160) that selects part of the displayed images, and an image processing operation (S230) that performs image processing on the selected images. Operations S110 through S210 of FIG. 7 are the same as those shown in FIG. 3. The method of FIG. 7 differs from that of FIG. 3 in that an operation (S218) in which a type of image processing is selected is performed after the slideshow function is completed (S200).

When the slideshow function is completed (S200), an operation (S210) of displaying reduced images included in a list created during the slideshow is performed. When the reduced images are displayed, an operation (S212) of receiving an input manipulation of a user may be performed. If the input manipulation of the user is received (S214), an operation (S216) of changing the images included in the list is performed.

The above operations can be specifically confirmed through the image processing apparatus 1 shown in FIG. 6. After the touch screen 50 of the image processing apparatus 1 displays the reduced images 57 included in the list, the user touches the touch screen 50 or manipulates the user input unit 60 so as to release the selection of the reduced images 57. That is, when the reduced images 57 are displayed on the touch screen 50, if the user manipulates the release selection menu 59b and contacts the reduced images 57, the selection of the reduced images 57 is released.

If the delete execution menu 59a is manipulated after the images included in the list are changed, the touch screen 50 may display the menus 51a through 51e shown in FIG. 4. The user may select a type of image processing to be performed on the selected images as described with reference to FIG. 4. This is an operation (S218) of selecting the type of image processing.

After the operation (S218) of selecting the type of image processing is performed, an operation (S220) of confirming whether to perform image processing may be performed. That is, when the user decides the type of image processing, the touch screen 50 displays the dialogue box 58 that asks the user whether to perform image processing as shown in FIG. 6. If the user touches the user input unit 60 or the touch screen 50 and selects “yes” from the dialogue box 58, image processing set in the operation (S218) that selects the type of image processing may be performed.

After the operation (S220) of confirming the user's opinion on whether to perform image processing is performed, an operation (S230) of performing image processing on the selected images is performed. When image processing is performed on the selected images, an operation (S240) of storing the images on which image processing has been performed may be performed.

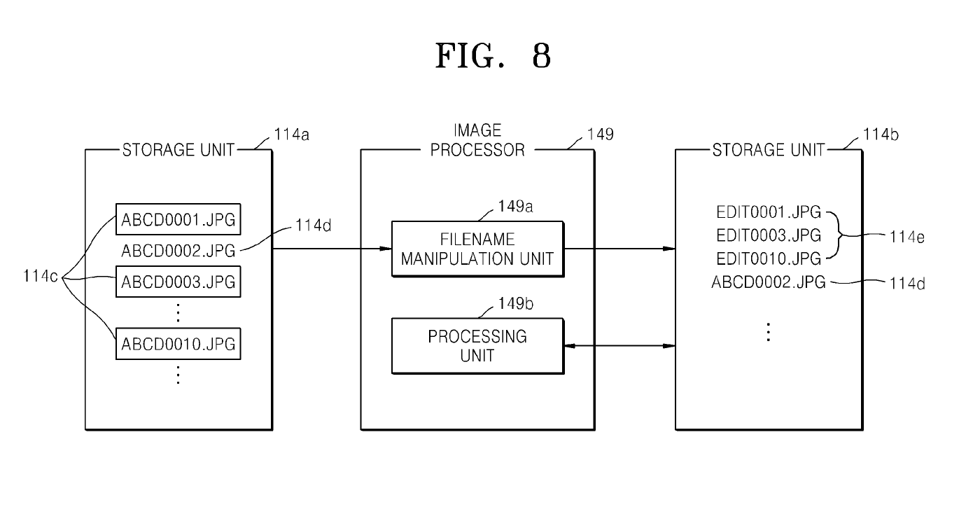

FIG. 8 is a conceptual view for explaining image processing performed by the image processing apparatus of FIG. 1, according to another embodiment.

Although the image processor 70 of the image processing apparatus described with reference to FIGS. 1 and 2 uses the list creating unit 47 to memorize the selected images when the slideshow function is performed, this should not be construed as limiting, as various methods of simultaneously performing image processing on the selected images after the slideshow function is performed or performing different image processing on the respective selected images may be used.

Referring to FIG. 8, an image processor 149 includes a filename manipulation unit 149a that inserts a common character string into filenames of images selected by a user when a slideshow function is performed.

Although two storage units 114a and 114b are the same as the storage unit 14 shown in FIG. 1, the storage unit 114a shows a status before the slideshow function is performed, and the storage unit 114b shows that a filename is changed by the filename manipulation unit 149a after the slideshow function is completed.

The filename manipulation unit 149a changes names of files 114c selected by the user when the slideshow function is performed. In more detail, the common character string “EDIT” is inserted into the names of the files 114c so that files 114e having changed names are stored in the storage unit 114b after the slideshow function is completed. Names of files 114d of the images that are not selected by the user remain unchanged.

The image processor 149 may perform image processing on the selected images. In more detail, a processing unit 149b performs image processing only on the files 114e having the common character string “EDIT” among the images stored in the storage unit 114b. After the processing unit 149b completes performing image processing, the filename manipulation unit 149a may change the names of the files 114e of the images on which image processing has been performed to the original names.

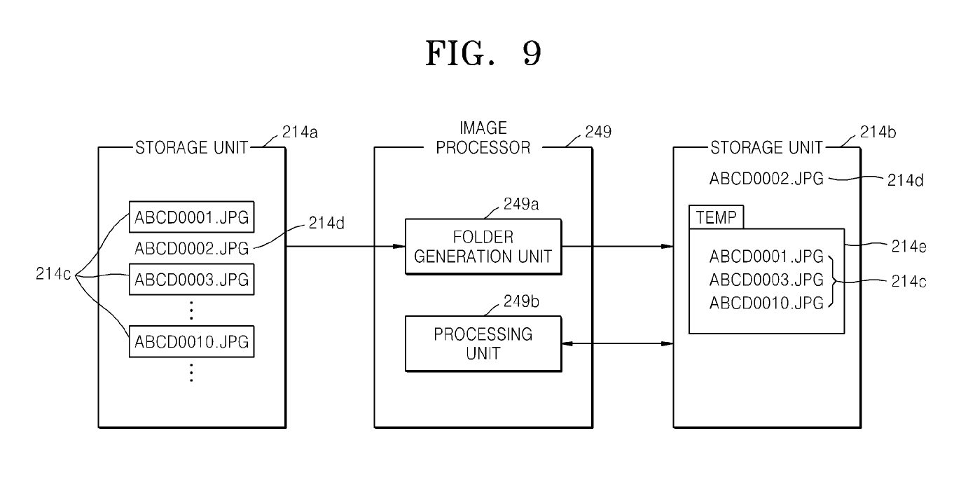

FIG. 9 is a conceptual view for explaining image processing performed by the image processing apparatus of FIG. 1, according to another embodiment.

Referring to FIG. 9, an image processor 249 includes a folder generation unit 249a and a processing unit 249b. The folder generation unit 249a generates a temporary folder TEMP 241e and moves files of images selected by a user to the temporary folder 214e when a slideshow function is performed.

Although two storage units 214a and 214b are the same as the storage unit 14 shown in FIG. 1, the storage unit 214a shows a status before the slideshow function is performed, and the storage unit 214b shows that the temporary folder 214e is generated by the folder generation unit 249a after the slideshow function is completed.

After the slideshow function is completed, files 214c selected by the user are moved to the temporary folder 214e from the storage unit 214a when the slideshow function is performed. Files 214d of images that are not selected by the user remain unmoved.

An image processor 249 may perform image processing on the selected images. In more detail, a processing unit 249b performs image processing only on files 214c included in the temporary folder 214e among the images stored in the storage unit 214b. After the processing unit 249b completes performing image processing, the folder generation unit 249a may move the files 214c on which image processing has been performed to original positions thereof and simultaneously delete the temporary folder 214e.

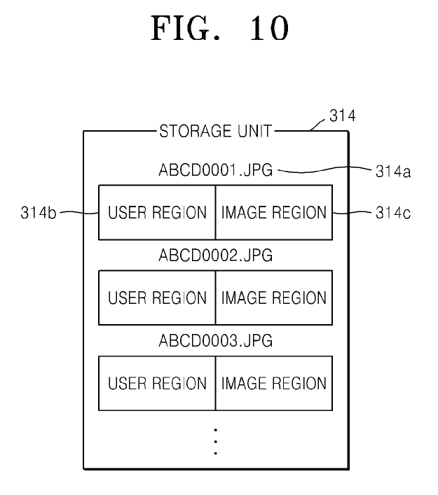

FIG. 10 is a conceptual view for explaining image processing performed by the image processing apparatus of FIG. 1, according to another embodiment.

Referring to FIG. 10, the image processor 70 of FIG. 1 does not use the list creating unit 47 and endows tags to files 314a of images selected by a user when a slideshow function is performed.

The files 314a stored in the storage unit 314 include an image region 314c in which information regarding the images is stored and a user region 314b that indicates other information, respectively. The image processor 70 endows a tag on the user region 314b of the files 314a selected by the user from among the files stored in the storage unit 314 when the slideshow function is performed. The image processor 70 does not endow a tag on the user region 314b of the files that are not selected by the user.

The user region 314b may be a maker note region of Exchangeable image file format (Exif). Exif is a storage format of an image file obtained with a digital camera or a digital camcorder. Exif is an image format that was standardized by the Japan Electronic Industry Development Association (JEIDA), is based on TIFF and JPEG, which are widely used, and includes unique information and operation regulations for digital cameras.

After the slideshow function is completed, the image processor 70 may perform image processing on the selected images. In more detail, the image processor 70 may perform image processing only on images including the tag endowed on the user region 314b from among the files 314a stored in the storage unit 314.

Although the same image processing is simultaneously performed on images selected by a user when a slideshow function is performed in the above-described embodiments, the image processing method should not be construed as limiting.

Types of image processing may be different according to each of a plurality of selected images. In various embodiments, more than one kind of image processing may be performed, and a plurality of image processing may be performed on one selected image.

For example, when images are selected while a slideshow function is performed, types of image processing to be performed on the selected images may be displayed after the slideshow is completed. In this regard, if a user selects types of image processing, a list of selected images may include types of image processing to be performed on each of the selected images.

As described above, according to embodiments of an image processing apparatus and method, a user may select desired images on which image processing is performed when a slideshow function is performed. After the slideshow function is completed, image processing may be simultaneously performed on the selected images, which is much more convenient than the conventional image processing apparatus and method that have performed image processing on files searched and selected after the slideshow function is completed.

As described above, for apparatuses and methods for digital image processing using a slideshow function according to various embodiments, users may select a plurality of images when the slideshow function is performed, and perform image processing on the selected images after the slideshow function is performed.

The apparatus described herein may comprise a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, magnetic tapes, floppy disks, and optical data storage devices. The computer readable recording media may also be distributed over network coupled computer systems so that the computer readable code is stored and executed in a distributed fashion. This media can be read by the computer, stored in the memory, and executed by the processor.

Also, using the disclosure herein, programmers of ordinary skill in the art to which the invention pertains can easily implement functional programs, codes, and code segments for making and using the invention.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. It will be recognized that the terms “comprising,” “including,” and “having,” as used herein, are specifically intended to be read as open-ended terms of art.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

What is claimed is:

1. An image processing apparatus having a slideshow function comprising:
a storage unit that stores files corresponding to a plurality of images;
a display unit that displays the plurality of images;
a slideshow performing unit that reads the files from the storage unit and sequentially displays the plurality of images on the display unit in a slideshow function;
a user input unit that receives input manipulation of a user and generates a signal; and
an image processor that performs image processing on the files corresponding to images selected from the plurality of images displayed on the display unit based on the signal of the user input unit after the slideshow performing unit completes the slideshow function.

2. The image processing apparatus of claim 1, wherein the image processor performs the same image processing on each of the selected images.

3. The image processing apparatus of claim 1, wherein, when the slideshow function is performed, the display unit displays selectable types of image processing to be performed on the selected images, the user input unit selects a type of image processing to be performed on each of the selected images, and the image processor performs image processing selected by the user input unit on each of the selected images.

4. The image processing apparatus of claim 1, wherein the image processing performed by the image processor comprises one operation selected from the group consisting of a deleting operation of deleting the selected files from the storage unit, a property editing operation of endowing a protection property on the selected files, and a printing operation of printing images corresponding to the selected files.

5. The image processing apparatus of claim 1, wherein the image processing performed by the image processor comprises one operation selected from the group consisting of a coloring operation of applying a color effect to the images corresponding to the selected files, a resizing operation of resizing the images, a rotating operation of changing orientations of the images, a cropping operation of cropping the images, and a redeye correction operation of correcting a red eye phenomenon that occurs in persons included in the images.

6. The image processing apparatus of claim 1, further comprising:
a list creating unit that creates a list of filenames of the selected images,
wherein the image processor performs image processing on the images included in the list.

7. The image processing apparatus of claim 1, wherein the image processor inserts a common character string in the filenames of the selected images, and the slideshow performing unit performs image processing on the selected images having the filenames including the common character string after completing the slideshow function.

8. The image processing apparatus of claim 1, wherein the image processor moves the files of the selected images to a temporary folder, and the slideshow performing unit performs image processing on the images stored in the temporary folder after completing the slideshow function.

9. The image processing apparatus of claim 1, wherein the image processor endows a tag on a user region of each of the files of the selected images, and the slideshow performing unit performs image processing on the images including the tag after completing the slideshow function.

10. An image processing method using a slideshow function comprising:
sequentially displaying a plurality of images;
receiving user manipulation of a user and selecting at least some of the displayed images when the slideshow function is performed; and
performing image processing on the selected images.

11. The image processing method of claim 10, wherein the performing of the image processing comprises: performing the same image processing on each of the selected images.

12. The image processing method of claim 10, wherein the sequentially displaying of the plurality of images comprises: displaying the selected images and selectable types of image processing to be performed on the selected images, the selecting of the at least some of the displayed images comprises: selecting a type of image processing to be performed on each of the selected images, and the performing of the image processing comprises: performing the selected image processing on each of the selected images.

13. The image processing method of claim 10, wherein the performing of the image processing comprises one operation selected from the group consisting of deleting the selected files from a storage unit, endowing a protection property on the selected files, and printing images corresponding to the selected files.

14. The image processing method of claim 10, wherein the performing of the image processing comprises one operation selected from the group consisting of applying a color effect to the images corresponding to the selected files, resizing the images, changing directions of the images, cropping the images, and correcting a red eye phenomenon that occurs in persons included in the images.

15. The image processing method of claim 10, further comprising:
creating a list of filenames of the selected images,
wherein the performing of the image processing comprises: performing image processing on the images included in the list.

16. The image processing method of claim 10, wherein the performing of the image processing comprises: inserting a common character string in the filenames of the selected images, and performing image processing on the selected images having the filenames including the common character string after the slideshow function is completed.

17. The image processing method of claim 10, wherein the performing of the image processing comprises: moving the files of the selected images to a temporary folder, and performing image processing on the images stored in the temporary folder after the slideshow function is completed.

18. The image processing method of claim 10, wherein the performing of the image processing comprises: endowing a tag on a user region of each of the files of the selected images, and performing image processing on the images including the tag after the slideshow function is completed.
